(19) United States
(12) Patent Application Publication
(10) Pub. No.: US 2006/0086014 A1
(43) Pub. Date: Apr. 27, 2006

(54) Gift bag assemblies with selectable complimentary components and related retail display

(76) Inventors: Michael Plank, Minneapolis, MN (US); Julie Lynn Everson, Rocky River, OH (US); Lisa Anne Egensperger, Concord, OH (US); Belinda Nemeth, Shaker Heights, OH (US)

Correspondence Address: ROETZEL & ANDRESS, 1375 EAST 9TH STREET, CLEVELAND, OH, 44114, US

(21) Appl. No.: 10/970,474

(22) Filed: Oct. 21, 2004

(51) Int. Cl. G09F 1/00

(52) U.S. Cl. 40/124.06

(57) ABSTRACT

Gift bag assemblies and related retail displays include multiple components which are selected and assembled to form unique gift bags. The display includes a plurality of each of the gift bag components which include bags which have a transparent pocket for receiving a decorative card, decorative cards which bear printed matter which is visible through the transparent pocket, and handles which have a gripping portion and an attachment portion and a fastener on the attachment portion for attachment to the bag. The consumer selects each of the components based upon occasion or design attributes and assembles a unique gift bag by insertion of a selected decorative card into the transparent pocket of the bag, and attachment of a selected handle to the bag.

### FIELD OF THE INVENTION

The present invention pertains generally to containers and packaging and, more particularly, to gift packaging in the form of bags.

### BACKGROUND OF THE INVENTION

Gift bags are a widely used packaging medium for gifts of small size. Their popularity stems from ease of use and a wide range of styles, colors and sizes available. The construction of such bags has been very conventional, largely due to low cost and ease of manufacture. Conventional gift bags are made of different types of printed paper, folded in a standard manner to form a reinforced square bottom, pleated sides, and a crease in one of the main side walls to enable the bottom of the bag to be folded flat with the walls. Paper construction affords a wide variety of print media and finishes which are the primary aesthetic sales-triggering attributes of gift bags. For the basic cubic folding bag, the necessity of a handle has been dealt with in the minimalist manner of a string or rope through opposed sides of the bag. This provides a means for carrying and closure, but does not add appreciably to the aesthetics of the bag other than through color coordination. Gift bags are a difficult product to bring variety to in a manner which makes efficient use of retail space. A greater variety of designs and styles would increase sales, but is not practical given that each group of bags of a particular design occupy a significant amount of retail space. The retail display of gift bags preferably accentuates the primary feature of the printed occasion theme, pattern and color, but such displays are static in the sense that a consumer may decide very quickly based upon this primary appearance of the bags. In other words, the choices are strictly limited to what is displayed.

### SUMMARY OF THE INVENTION

The present invention provides a gift bag packaging system and a related retail display by which a consumer can selectively assemble a gift bag with different structural and decorative elements. In one version of the invention, a display of gift bag components is provided which includes a bag made of paper or other suitable material which can be folded or otherwise configured for compact retail display in multiples and arranged by color, style, theme or other category. Each bag has at least one major panel which includes a pocket for receiving a decorative card. A plurality of decorative cards dimensioned to be received in the pocket of a bag are also arranged on the same or adjoining display, also by color, style, theme or other category. A plurality of handles adapted for engagement with one or more panels of a bag are also arranged on the same or adjoining display, also by color, style, there or other category. With these three principle components of the so arranged and displayed, a consumer can select each component of a gift bag for assembly by insertion of a selected decorative card into the bag pocket, and attachment of a selected to the bag by the described mechanisms for engagement.

### DESCRIPTION OF THE DRAWINGS

FIG. 1 is an elevation of a retail display layout for selectable gift bag components in accordance with the invention;

FIG. 2 is a an elevation of a panel of a gift bag of the present invention;

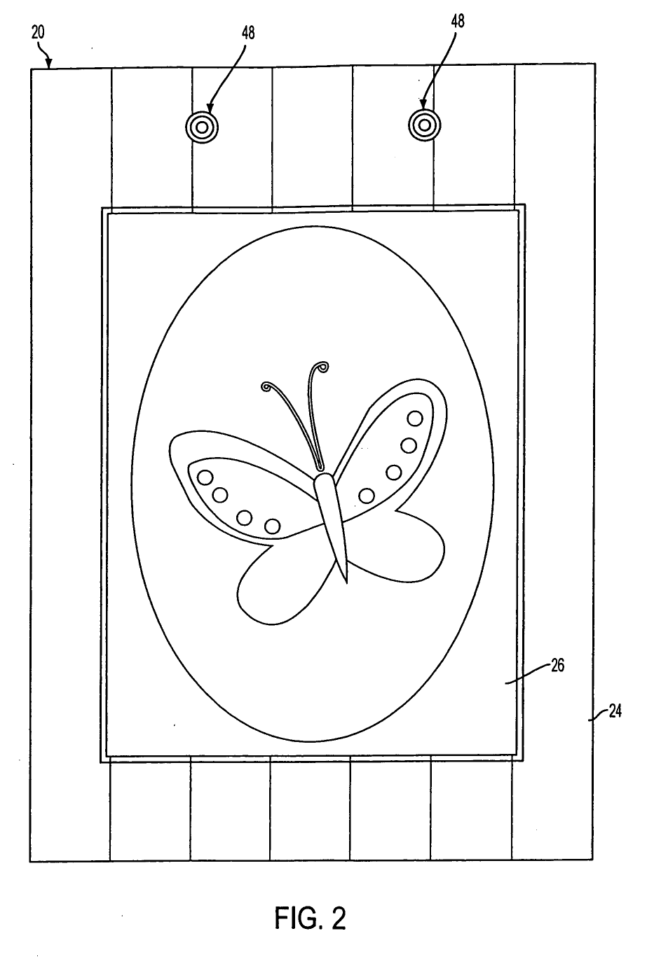

FIG. 3 is a cross-sectional view of an engagement of a handle with a portion of a gift bag in accordance with the invention, and

FIG. 4 is a side elevation of a gift bag and handle combination in accordance with the present invention.

### DETAILED DESCRIPTION OF PREFERRED AND ALTERNATE EMBODIMENTS

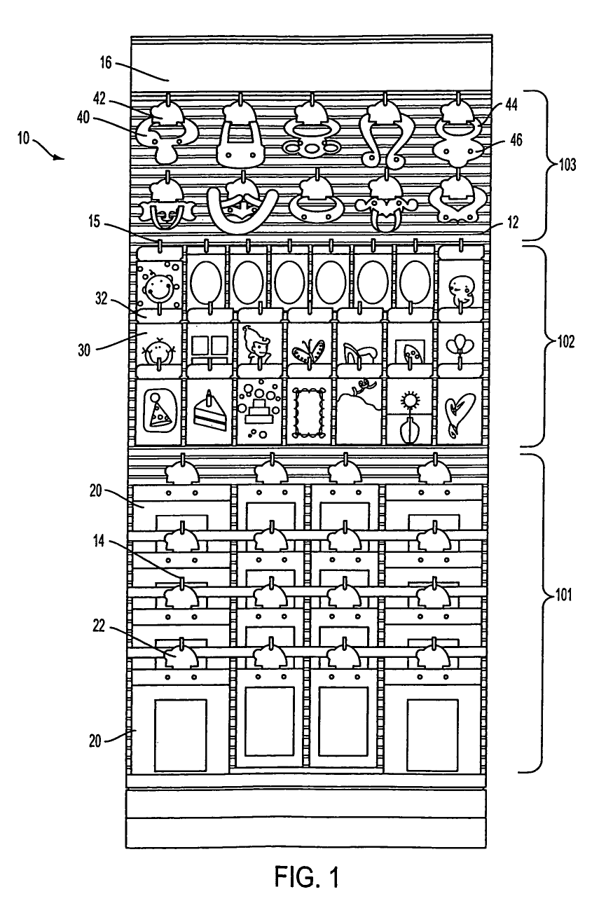

FIG. 1 is a schematic representation of one type of retail display, indicated generally at 10, such as may be constructed for use in any retail environment such as within a store or as a kiosk standing alone or in combination with other structures or displays. The display 10 has a generally planar panel 12 which provides a structural backing for attachment of hangers or other types of fasteners from which the gift bag components can be suspended or otherwise removably attached. One type of panel 12 which can be used in connection with the display is a known as slat wall, which has an array of horizontally disposed grooves in which different types of bracketry and hanging devices are engaged for suspension of products therefrom. Other types of panels are also suitable, such as peg-board or custom-made panels with engagements for multiple types of product hanger brackets. In the display of the present invention, hanger hardware is provided which is configured to support at least three different types or sizes of products or objects, such as the bags, insert panels and handles. This may be accomplished by a single type of hanger hardware, or with different types of sizes for each component of the gift bag assembly.

As further shown in FIG. 1, a first area 101 of the display 10 is devoted to the display of a plurality of bags 20. The bags 20 are of the conventional folded type with four panels, including two generally opposed main panels 24 and two generally opposed pleated side panels 28, a bottom 29 to which each of the four panels is attached, and an open end generally opposite the bottom 29. Each of the bags 20 may be fitted with a hang tag 22, which is attached to one of the bag walls, and suspended upon a hook 14 which projects from the panel 12. Alternatively the bags can be engaged directly with a hook or other display engagement device. The bags can also be grouped by size. The bags 20 are arranged in a manner which makes visible an appreciable area of a panel of each one so that selection based upon color, style, size or theme is facilitated. Although shown in generally rectangular form, it is understood the bag component of the invention can be in many different forms, such as bags which have generally square panels, trapezoidal panels, or any other shapes or sizes. The bags 20 may also be oriented to show a main panel 24 to which a transparent pocket 26 is attached, to indicate to the consumer that the bags are configured to receive a decorative card dimensioned to be inserted into and received by the transparent pocket 26. The transparent pocket 26 can be for example a piece of sheet form cellophane or other opaque material which is adhered to an outer surface of one of the main panels 24 of the bag 20. Alternatively, a pocket or sleeve can be formed on the interior of the bag, with an opening in the corresponding main panel 24 through which the pocket and its content is visible. Although the bags are illustrated as located in area 101 in a lower region of the display 10, they can be positioned in any area of the display and do not necessarily have to be grouped all together but may be distributed in different areas of the display. The bags 20 when made of paper or card stock or other printable material are printed in color and with a theme, style or design, all or any part of which is referred to herein as a “design attribute” of the bag 20. The size and shape of the bag is also a design attribute of the bag.

In a second area 102 of the display 10 are grouped a plurality of decorative cards 30, which may be directly engaged with or suspended from hangers on the display, or attached to display tags 32 which are engaged with or suspended from hangers. The cards 30 are arranged so as to make visible an appreciable portion of each card for selection by color, style or theme, and for matching with a bag 20. Although illustrated as located in common area 102 in a central region of the display 10, the cards 30 can be positioned in any area of the display and do not necessarily have to be grouped all together but may be distributed in different areas of the display. Each of the cards, made of paper or card stock or other printable material, bears printing of certain colors, style, theme or design, all or any part of which is referred to herein as a “design attribute” of the card 30. The consumer selects a card 30 for combination with a selected bag 20 by insertion of the card 30 into the pocket 26. The selection of a card 30 for combination with a bag 20 may or may not be based upon coordination of the respective design attributes of the card and bag.

In a third area 103 of the display 10 are grouped a plurality of handles 40, which may be directly engaged with or suspended from hangers on the display, or attached to display tags 42 which are engaged with or suspended from hangers 16. The handles 40 are arranged so as to make visible the entirety of or at least an appreciable portion of each handle from the front of the display in order to assist in coordination with a selected bag 20 and card 30 in accordance with the invention. Although the handles 40 are illustrated as located in a common area 103 in an upper region of the display 10, they may be positioned in any area of the display and do not necessarily have to grouped all together but may be distributed in different areas of the display. The physical form of the handles 40 may vary widely to include any form which provides a gripping section 44 and an attachment section 46 for attachment to a panel of a bag. One type of handle is generally planar, in the form of a die-cut piece from sheet form material of any shape which has the described gripping and attachment sections. The handles 40 can be made from any suitable material, such as card stock, paper board, foam, rubber, plastic or woven or non-woven sheet or any other material from which different handles in different shapes can be made by cutting or die-cutting. The shapes and colors of the handles 40 are referred to herein as “design attributes” of the handles, which may further include accessories attached to the handles, such as ornamentation such as beads, sequins, appliques, printing, embossing, texturing or any other objects which serve as decoration of the handle.

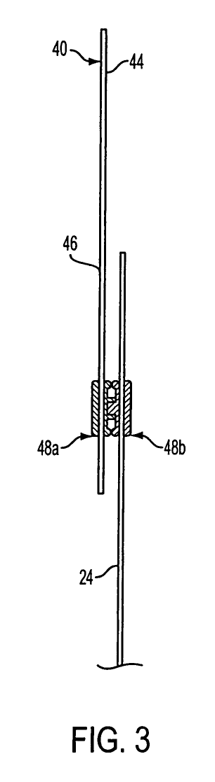

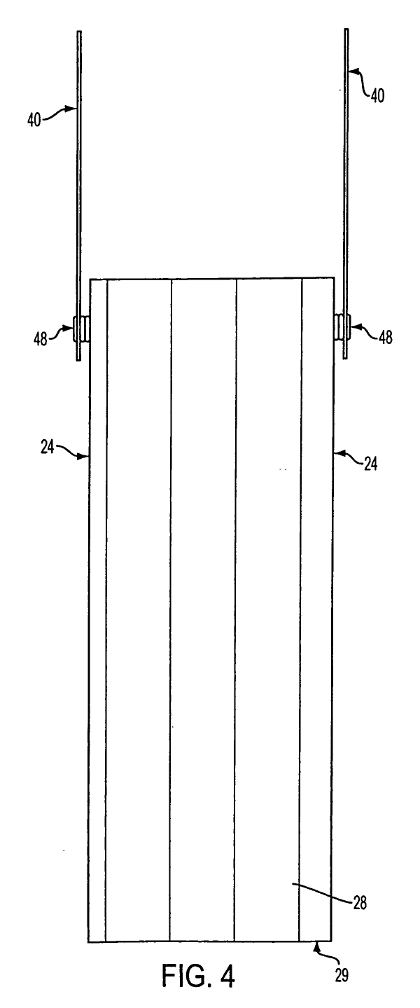

The invention further includes one or more fastening devices for attaching one or more handles 40 to a selected bag 20 to complete the coordinated gift bag. One type of fastener which can be used in the aspect of the invention is one or more two part snaps, as shown at 48, with a first half 48a secured to the handle 40, and a second half 48b secured to one of the panels of the bag 20 for attachment of the handle 40 to the bag 20 as shown in FIGS. 3 and 4. As shown in FIG. 3, the handle 40 may be attached to an interior side of the bag panel 24 or, as shown in FIG. 4, to the exterior side of bag panel 24. As further shown in FIG. 4, a second handle 40 may be attached to the opposite bag panel 24. Other types of fasteners such as hooks, rivets, Velcro™ or adhesive may also be employed to accomplish attachment of the handle or handles 40 to the bag 20.

In practice the display 10 of FIG. 1 is located in a retail environment where a shopper can approach the display and readily view each of the plurality of components of the gift bag assembly for selection. Instructions on selection and assembly or creation of a gift bag (gift bag assembly) may be located anywhere on the display. The consumer selects the components and assembles them accordingly to create a custom gift bag. Other coordinating or complimentary products, such as gift tags and tissue paper, may be incorporated into the display 10. By separating each of the components of the gift bag assembly on a single display, each component can be tagged, priced and sold separately, or a complete gift bag assembly can be sold as a combined unit.

What is claimed as the invention is:

1. A gift bag assembly comprising:
(a) a bag having four interconnected side panels and a bottom panel, including two generally opposed main panels and two generally opposed side panels, the main panels and side panels each terminating at the bottom panel and each terminating in a common plane at an open end of the bag;
(b) a transparent pocket attached to one of the main panels, the transparent pocket having a an opening oriented toward the open end of the bag;
(c) an card positioned within the transparent pocket through the opening of the transparent pocket, and
(d) a handle having a grip portion and an attachment portion, the attachment portion having at least one fastening device attached to the attachment portion of the handle and to a main panel of the bag.

2. The gift bag assembly of claim 1 wherein a design attribute of the card is coordinated with a design attribute of the bag.

3. The gift bag assembly of claim 1 wherein a design attribute of the handle is coordinated with a design attribute of the bag or card.

4. The gift bag assembly of claim 1 further comprising a second handle attached to another main panel of the bag.

5. The gift bag assembly of claim 1 wherein the handle is in the form of a die-cut piece from sheet material.

6. The gift bag assembly of claim 1 wherein the fastening device is a two part snap with a first part of the snap attached to the handle and a second part of the snap attached to the bag.

7. The gift bag assembly of claim 1 in combination with a retail display adapted to support and display a plurality of bags, cards and handles.

8. A gift bag assembly comprising: a bag having four side panels including two main panels and two side panels and a bottom, each of the side panels extending from the bottom;
a transparent pocket attached to one of the main panels;
a card in the transparent pocket, the card having a printed color, theme or style which is visible through the transparent pocket;
a handle formed from a planar material and having a grip portion and an attachment portion, the grip portion being shaped different from the attachment portion, and a fastener which fastens the attachment portion of the handle to a panel of the bag so that the grip portion of the handle extends beyond a panel of the bag.

9. The gift bag assembly of claim 8 wherein the card occupies substantially all of the transparent pocket.

10. The gift bag assembly of claim 8 wherein a design attribute of the card is coordinated with a design attribute of the bag.

11. The gift bag assembly of claim 8 wherein the handle is attached to a panel of the bag by a two part snap fastener, with a first part of the snap fastener secured to the attachment portion of the handle, and a second part of the snap fastener secured to a panel of the bag.

12. The gift bag assembly of claim 8 wherein a design attribute of the handle is coordinated with a design attribute of the bag or card.

13. A gift bag assembly display for displaying a plurality of gift bag components for selection and combination into a gift bag assembly, the gift bag assembly display comprising:
a panel having a plurality of fixtures attached thereto and configured to support at least three different components of a gift bag assembly including bags with a transparent pocket on one panel of each of the bags, cards dimensioned to fit within the transparent pockets of the bags, and handles which can be attached to the bags, each of the three different components being generally grouped together on the panel.

14. The gift bag assembly display of claim 13 further comprising an area of the panel for display of gift bag accessories such as gift cards and tissue paper.

15. The gift bag assembly display of claim 13 further comprising instructions for creating a gift bag assembly.

16. A gift bag assembly assembled by selection and combination of one of each of the gift bag components from the display of claim 13.

17. A gift bag assembled by selection and assembly of gift bag components selected from a display of a plurality of gift bag components, the gift bag components including: a bag having two generally opposed main panels and two generally opposed side panels, each of the panels being attached at one end with a bottom, and a transparent pocket attached to one of the main panels;
a card inserted in the transparent pocket,
and a handle having a gripping portion and an attachment portion, and a fastener on the attachment portion for attachment to a main panel of the bag.

18. The gift bag assembly of claim 17 wherein each of the gift bag components has a design attribute, and a design attribute of one of the components is coordinated with a design attribute of another component.

19. The gift bag assembly of claim 17 wherein the gift bag components are selected from groups of each of the components on the display.

20. A retail display for displaying a plurality of gift bag components which can be assembled to form a gift bag, the retail display comprising:
a panel for support a plurality of gift bag components including:
bags, each bag having generally opposed main panels and generally opposed side panels and a bottom, and a transparent pocket attached to one of the panels;
cards, each card bearing printed matter and dimensioned to fit within a transparent pocket of a bag so that the printed matter is visible, and
handles, each handle having a gripping portion and an attachment portion, and a fastener on the attachment portion for attachment to the bag.
